(19) United States
(12) Patent Application Publication
(10) Pub. No.: US 2010/0019018 A1
(43) Pub. Date: Jan. 28, 2010

(54) Method And Device For Wetting The Bumps Of A Semiconductor Chip With Soldering Flux

(76) Inventors: Damian Baumann, Muri (CH); Ruedi Grueter, Buttisholz (CH); Dominik Werne, Oberaegeri (CH)

Correspondence Address: Nixon Peabody LLP, P.O. Box 60610, Palo Alto, CA, 94306, US

(21) Appl. No.: 12/442,389

(22) PCT Filed: Sep. 11, 2007
(86) PCT No.: PCT/EP07/59545

§ 371 Date: Mar. 20, 2009

(30) Foreign Application Priority Data
Sep. 21, 2006 (CH) 1506/06

(51) Int. Cl. B23K 1/20; B23K 3/08

(52) U.S. Cl. 228/223; 228/33

(57) ABSTRACT

The present invention relates to a method and a device for wetting the bumps of a semiconductor chip with a soldering flux, in which a container, which accommodates the soldering flux and is open on the bottom, and a base plate, which contains at least one cavity, are moved back-and-forth in relation to one another on one side of the cavity to the other side of the cavity. The viewed in the movement direction front wall of the container is lifted up during the relative movement, so that it is located at a distance above the base plate. The distance is somewhat greater than the height difference by which the soldering flux projects above the level of the surface of the base plate. This measure has the effect that the front wall of the container does not convey any soldering flux onto the base plate, which has caused the loss of this soldering flux until now.

### CROSS REFERENCE TO RELATED APPLICATIONS

The present application is related to and claims priority of the PCT patent application no. PCT/EP2007/059545 entitled “Method And Device For Wetting Bumps Of A Semiconductor Chip With Soldering Flux”, filed Sep. 11, 2007, which in turn claims priority of Swiss patent application no. 1506/06, filed on Sep. 21, 2006, the disclosure of which is herein incorporated by reference.

### TECHNICAL FIELD

The present invention relates to a method and a device for wetting the bumps of a semiconductor chip with soldering flux.

### BACKGROUND OF THE INVENTION

For mounting semiconductor chips a technology is widespread in which the semiconductor chips are initially attached to a substrate using a so-called die bonder. Subsequently, the electrical connection areas of the semiconductor chip are wired to the substrate using a so-called wire bonder. Another technology is flip chip technology, in which the connection areas of the semiconductor chip are provided with a so-called bump. During mounting on a substrate, the semiconductor chip is turned over, which is referred to in technical jargon as the “flip”. The bumps of the semiconductor chip are then wetted using a soldering flux. For this purpose, the bumps of the semiconductor chip are immersed in a cavity filled with soldering flux, for example. Subsequently, the semiconductor chip is placed on the substrate, the bumps contacting electrical connection areas of the substrate. The semiconductor chip and the substrate are then soldered in a furnace.

A device for wetting the bumps of a semiconductor chip with a soldering flux is known from U.S. Pat. No. 6,293,317. This device contains a base plate having at least one cavity, which is filled with soldering flux and is refilled by the back-and-forth movement of a container, which is open on the bottom, after each wetting of the bumps of a semiconductor chip. The level of the mean soldering flux layer in the cavity is typically in a range from 0 to 200 micrometers.

Further devices for wetting the bumps of a semiconductor chip are known from EP 789391, WO 01/35709, and JP 8-340175.

All of these devices share the disadvantage that the loss of soldering flux is relatively large.

The present invention is based on the object of developing a device of this type whose loss of soldering flux is significantly less.

### SHORT DESCRIPTION OF THE INVENTION

The present invention relates to a device in which a container receiving the soldering flux, which is open on the bottom, and a base plate, which contains at least one cavity, are moved back-and-forth in relation to one another from one side of the cavity to the other side of the cavity. The named object is achieved by a method in which the front wall of the container, viewed in the movement direction, is lifted up during the relative movement, so that it is located at a distance A above the base plate. The distance A is somewhat greater than the height difference by which the soldering flux projects beyond the level of the surface of the base plate. Because this height difference is typically only a few micrometers, the front wall of the container also has to be lifted up only very little. The distance A is typically in the range from 20 to 200 micrometers. This measure brings about that the front wall of the container does not convey any soldering flux out of the cavity onto the base plate, which until now has caused the loss of this soldering flux.

According to the present invention, a device capable of performing the method has means for lifting up the front wall of the container viewed in the movement direction. The container is preferably mounted in such a way that the friction arising during the relative movement between the container and the base plate exerts a torque on the container, so that the container automatically tilts around the lower edge, which rests on the base plate, of the rear wall of the container viewed in the movement direction during the relative movement. On the other hand, an additional active drive may be provided, which tilts the container around the lower edge of the rear wall in each case before the beginning of the movement. The active drive may be of a mechanical, electromechanical, pneumatic or hydraulic nature.

Exemplary embodiments of devices which are capable of performing the method according to the present invention are explained in greater detail in the following on the basis of the drawing. The figures are not to scale.

### DESCRIPTION OF THE DRAWING FIGURES

FIGS. 1, 2 show a top view and a lateral view of a device for wetting the bumps of a semiconductor chip according to CH 694634,

FIG. 3 shows a base plate of this device having a cavity,

FIG. 4 shows a first exemplary embodiment of a device for wetting the bumps of a semiconductor chip according to the present invention,

FIG. 5 shows a second exemplary embodiment of a device according to the present invention,

FIG. 6 shows a third exemplary embodiment of a device according to the present invention, and

FIG. 7 shows a fourth exemplary embodiment of a device according to the present invention.

### DETAILED DESCRIPTION OF THE INVENTION

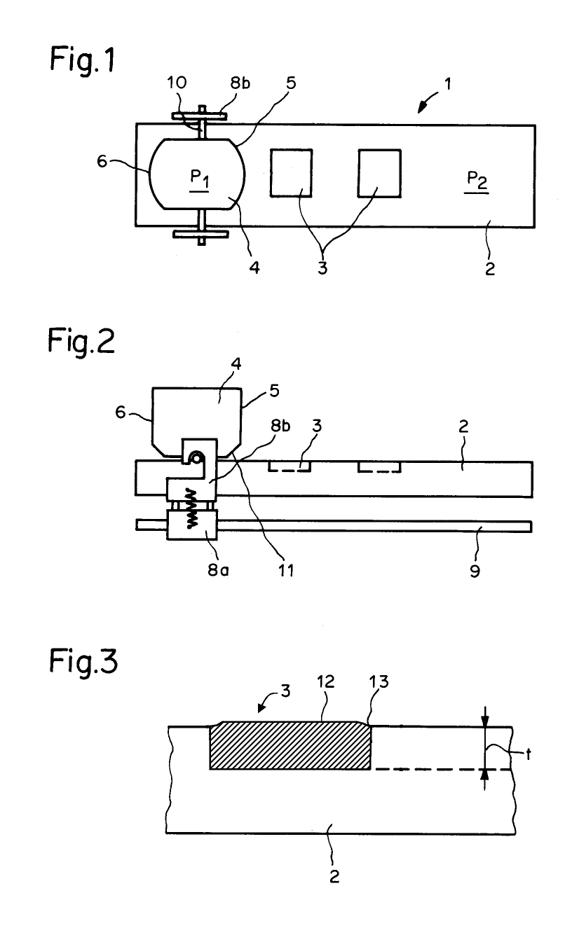

FIGS. 1 and 2 show a top view and a lateral view of a device 1, known from CH 694634, for wetting the bumps of a semiconductor chip with soldering flux which may have the form of a liquid substance, electrically conductive epoxy, or soldering paste. The device 1 comprises an oblong base plate 2, into which at least one cavity 3 is incorporated, and a container 4, which is open on the bottom, for accommodating the liquid substance. In operation, the container 4 slides back-and-forth at a predefined velocity on the base plate 2 between two positions P₁ and P₂, which are located on the left and right of the cavity 3. The container 4 has two walls 5 and 6, which alternately represent the front or rear wall in relation to the movement direction.

The container 4 is driven using a slide, for example, to which the container 4 is removably attached. The slide comprises a bottom and a top slide part 8a and 8b. The container 4 has two pins 10, which are mounted in a circular recess in the top slide part 8b. The top slide part 8b is drawn by means of a spring against the bottom slide part 8a in the direction toward the base plate 2, so that the lower edge of the container 4 is pressed against the base plate 2 with a predetermined force. The slide 8 itself is moved back-and-forth using a pneumatic drive (not shown), for example, along a guide rail 9 running parallel to the base plate, thereby moving also the container 4 sliding on the base plate 2.

FIG. 3 shows the cavity 3 filled with the soldering flux 12. The cavity 3 has a depth t. The soldering flux 12 extends along the circumference of the cavity 3 up to the upper edge 13 of the cavity 3. It frequently occurs that the soldering flux projects beyond the level of the surface of the base plate 2 enclosing the cavity because of surface tension. The cavity 3 is filled homogeneously with flux 12, the viscosity of the flux 12 not playing a role in a broad range from at least 8 to 45 Ns/m² (8000 to 45000 cp). Therefore, all bumps are uniformly wetted with soldering flux upon immersion of a semiconductor chip provided with bumps in the cavity 3.

The present invention may be implemented in a device of this type in that the drive of the container 4 is altered in such way that the front wall of the container 4 viewed in the movement direction is lifted up somewhat during the back-and-forth movement, so that the lower edge of the front wall is moved over the base plate 2 at a distance above the surface of the soldering flux. The lower edge of the rear wall of the container 4 contacts the base plate 2 and slides on the surface of the base plate 2, so that it strips the soldering flux uniformly like a spatula.

In the following, various solutions are shown for how the front wall of the container 4 may be lifted up during the movement along the base plate 2. A steel plate is frequently used as the base plate 2, which has been milled and mechanically processed from solid material to obtain an even surface having the required fineness. The cavity is subsequently formed by milling. Instead of such a base plate 2, however, a carrier plate may also be used, into which a steel sheet having an incorporated cavity, preferably produced by etching, is inserted. Therefore, the term base plate is also to be understood to mean such a steel sheet.

### Example 1

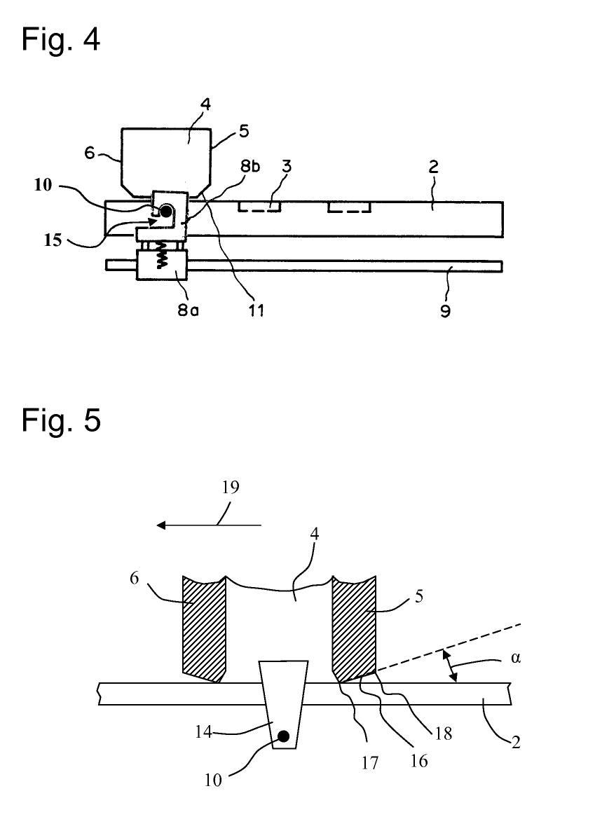

In this example, the drive known from CH 694634 is modified in such a way that the drive exerts a torque on the container 4, so that the front wall is automatically lifted up from the base plate 2 during the movement. As described above, the container 4 is driven by the slide formed by the bottom and the top slide parts 8a and 8b, in which the container 4 is removably mounted. The modifications of the drive are obvious from FIG. 4, which shows the modified drive in a lateral view. A plate 14 (not visible in FIG. 4, but implemented as in the example of FIG. 5), is attached in each case to the two side walls, which projects downward laterally adjacent the base plate 2. The plates 14 contain pins 10, which engage in a recess 15 in the top slide part 8b situated below the level of the top side of the base plate 2. The spring pulls the top slide part 8b downward against the guide rail 9. When the bottom slide part 8a is moved along the guide rail 9, the top slide part 8b exerts a force directed in the movement direction on the plates 14. This force causes the container 4 to also perform the movement of the slide on one hand, and generates a torque acting on the container 4 on the other hand, which causes the container 4 to be tilted around the lower edge of the rear wall. Because the rear wall rests on the base plate 2, the front wall lifts up from the base plate 2. The strength of the torque and thus the degree of tilting is essentially a function of three factors, namely the distance of the pins 10 from the top side of the base plate 2, the strength of the force of the spring, and the viscosity of the soldering flux. The distance of the lower slide part 8a to the guide rail 9 is therefore advantageously adjustable. If this distance is increased, the force exerted by the spring increases and thus also the torque. Pins 10 and recess 15 may be exchanged, of course, i.e., the pins 10 may also be fastened to the slide part 8b and the recess 15 may be applied in the plates 14.

### Example 2

This example is based on the preceding example, but the lower edges of the walls 5 and 6 of the container 4, which are each alternately the front or rear wall, are implemented in such a way that the container 4 comes to rest on a surface 16 upon tilting. FIG. 5 shows a possible solution. If the drive moves the container 4 in the direction identified by the arrow 19, the force being transmitted at the pin 10, the wall 6 is the front wall and the wall 5 is the rear wall. The lower edge of such a wall 5, 6 comprises an inner edge 17 and an outer edge 18, which delimit the cited surface 16. In the rest state, the container 4 lies on the inner edges 17 of the front and rear wall. The surface 16 runs slightly diagonally upward at a predetermined angle a originating from the inner edge 17 to the outer edge 18, so that the outer edge 18 does not contact the base plate 2 in the rest state of the container 4. During the movement, the container 4 tilts as a result of the force engaging at the pin 10 and the torque thus generated around the inner edge 17 of the rear wall. If the generated torque exceeds a first value M₁, the container 4 tilts so far that it comes to rest on the surface 16. This surface 16 is so wide that the container 4 only tilts around the outer edge 18 if the torque exceeds a second value M₂>M₁. With this design of the lower edge, the distance of the lower edge of the front wall from the base plate 2 is independent of the torque in the torque range from M₁ to M₂. Such a design offers the advantage that it provides a robust operating range in the event of changing operating conditions and unpredictably changing external conditions, within which the front wall of the container 4 is lifted up by a precisely defined distance from the top side of the base plate 2. FIG. 5 is not drawn to scale, in particular, the angle α is illustrated much larger than it actually is.

### Example 3

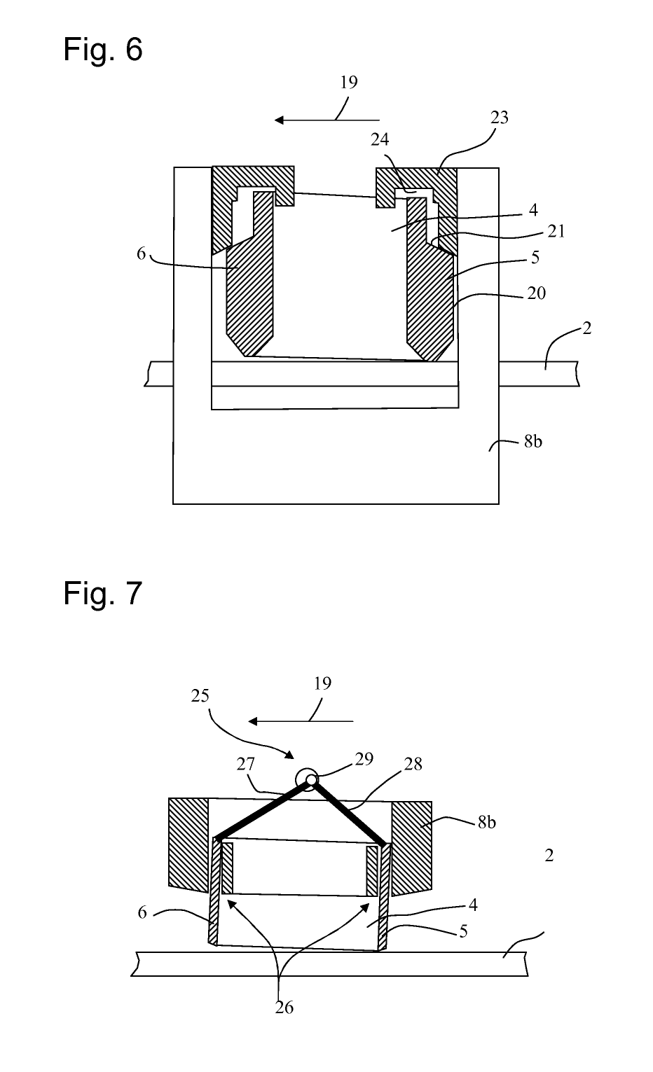

In this example, the force generated by the drive engages above the base plate 2. A top slide part 8b is also provided here. FIG. 6, which is not drawn to scale, shows the front and rear walls 6, 5 of the container 4 in a sectional view. The section plane runs perpendicularly to the base plate 2 and parallel to the movement direction of the container 4 represented by an arrow 19. The front and the rear walls have a lower edge which is narrower than the thickness of the wall. The walls have a surface 21 running diagonally upward on their exterior side 20. The top slide part 8b has surfaces diametrically opposite this surface 21 having the same angle of inclination. The top slide part 8b additionally contains a projection 23 having a groove 24, into which the top end of the front or rear wall projects. If the slide is moved in the direction of the arrow, the top slide part 8b exerts a torque on the container 4, which causes the container 4 to tilt around the lower edge of the rear wall. The top end of the front wall comes to a stop on the delimitation surface of the groove 24. In this example as well, the distance of the lower edge of the front wall from the base plate 2, which results during the back-and-forth movement, is largely independent of the operating conditions.

### Example 4

In this example, the container 4 is tilted around the rear edge using an active drive. The active drive may be of a mechanical, electromechanical, pneumatic or hydraulic nature. In this example, the drive is of a mechanical nature. FIG. 7, which is not drawn to scale, again shows the top slide part 8b, which is expanded by a simple mechanical drive 25, which is attached to the top slide part 8b. The top slide part 8b contains two guides 26, into which the top end of the front and the rear walls 6, 5 (in relation to the movement direction) of the container 4 project. A first rod 27 is fastened to the top end of the front wall and a second rod 28 is fastened to the top end of the rear wall via a joint. The other ends of the two rods 27 and 28 are also attached via a joint to an eccentric 29. In the position shown, the eccentric 29 presses the rear wall 5 of the container 4 against the base plate 2 and pulls the front wall 6 of the container 4 away from the base plate 2. Upon the direction change of the container 4 at the locations P₁ and P₂ (FIG. 1), the eccentric 29 is rotated into another position, so that it now presses the particular other wall of the container 4 against the base plate 2 or lifts it therefrom, respectively.

### Further Examples

In the devices described on the basis of FIGS. 4 through 7, the base plate 2 is situated fixed in place and the slide is used as a drive to move the container 4 back-and-forth. However, it is also possible for all of these devices to fix the slide in place and to move the base plate 2 in relation to the container 4 using a drive. If the slide is fixed in the device shown in FIG. 4 and the drive moves the base plate 2 back-and-forth, the slide is used on the one hand as a mechanism to be able to take out the container easily. On the other hand, the friction force arising between the base plate 2 and the container 4 during the movement of the base plate 2 generates a torque acting on the container 4, because the coupling point between the slide part 8b and the container 4 (in the form of the recess 15 and the pin 10) lies below the level of the base plate 2. The torque causes the container 4 to tilt around the lower edge of the rear wall, viewed in the movement direction of the base plate 2.

This is also the case for the devices shown in FIGS. 5 and 6, if the base plate 2 is moved back-and-forth and the container is situated fixed in place. Here as well, the friction arising between the base plate 2 and the container 4 causes a torque which tilts the container 4 around the rear wall, viewed in the movement direction of the base plate 2.

The container 4 may also be situated fixed in place and the base plate 2 may be moved back-and-forth in the device shown in FIG. 7.

The device according to the present invention offers multiple advantages:
The loss of soldering flux is much less than in the prior art.
The wear of the lower edges of the two walls is halved.

1. A method for wetting the bumps of a semiconductor chip with soldering flux, the method comprising
moving a container, which accommodates the soldering flux and is open on the bottom, and a base plate, which contains at least one cavity, relative to one another, wherein during the relative movement the container slides on the base plate from one side of the cavity to the opposite side of the cavity with the viewed in the movement direction front wall of the container lifted up, so that the front wall of the container is located at a distance above the base plate, and
immersing the bumps of the semiconductor chip in the cavity.

2. A device for wetting the bumps of a semiconductor chip with soldering flux, the device comprising
a base plate, which contains at least one cavity and a surface enclosing the cavity,
a container, which is open on the bottom, for accommodating soldering flux,
a drive for moving the container and the base plate back-and-forth relative to one another, and
means for lifting up the viewed in the movement direction front wall of the container.

3. The device according to claim 2, wherein the container is mounted in such a way that the friction arising between the container and the base plate during the relative movement exerts a torque on the container, so that the container tilts during the relative movement around the viewed in the movement direction rear wall of the container.

4. The device according to claim 2, wherein the drive comprises a slide movable parallel to the surface of the base plate, wherein said means for lifting up comprise plates fastened to side walls of the container, either the plates having a recess situated below the surface of the base plate, in which pins fastened to the slide engage, or the plates have pins situated below the surface of the base plate, which engage in a recess situated in the slide.
